(19) United States
(12) Patent Application Publication
(10) Pub. No.: US 2021/0113432 A1
(43) Pub. Date: Apr. 22, 2021

(54) PHARMACEUTICAL PACKAGING

(71) Applicant: SCG CHEMICALS CO., LTD., BANGKOK (TH)

(72) Inventors: CHRIS LEFTERI, LONDON (GB); MASSIMO MICOCCI, LONDON (GB); SUPATHIDA RATASAWAT, BANGKOK (TH); KANAWOOT VIRAVAIDHYA, BANGKOK (TH); VICHITVANNA BURAPACHIT, BANGKOK (TH); WACHIRAPHON SINTHAVATHAVORN, BANGKOK (TH)

(21) Appl. No.: 17/254,641

(22) PCT Filed: Jun. 20, 2019
(86) PCT No.: PCT/IB2019/055191

§ 371 Date: Dec. 21, 2020

(30) Foreign Application Priority Data
Jun. 26, 2018 (SG) 10201805513X

(51) Int. Cl. A61J 1/03; B65D 75/32; B65D 75/58

(52) U.S. Cl. CPC A61J 1/035; B65D 75/326; B65D 2575/3227; B65D 75/585; B65D 75/327

(57) ABSTRACT

The present invention discloses a packaging apparatus having a pod (1) containing product (3), and a retaining layer (2) which closes the pod (1) so that the product (3) is held captive within the pod (1), the pod (1) and/or the retaining layer (2) has a predetermined frangible feature which provides a weakened portion (4) in part of the surface of the pod (1) and/or the retaining layer (2) and thereby the weakened portion (4) is broken by deforming the pod (1) to get access to the product (3).

### FIELD OF INVENTION

The invention relates to a container specially adapted for medical or pharmaceutical purposes. More particularly, the invention relates to a packaging apparatus for people affected by arthritis or with reduced hand dexterity.

### BACKGROUND OF THE INVENTION

A pharmaceutical packaging is generally composed of one plastic container and one multi-layered retaining layer sealed on an opening of the plastic container. The plastic container, also known as a pod, is usually configured with a deep drawn recess for containing a product. The pharmaceutical packaging is commonly found in clinics, hospitals or pharmacies. Other than containing the product, the pharmaceutical packaging also ensures the product is not contaminated by environment such as UV ray, surrounding air or moisture through proper sealing of retaining layers on the opening, or by utilising opaque or transparent plastic containers. In this application, the product refers to an article of medication that can be in solid, semi solid, gel or liquid form.

A conventional way to get the medication from the pharmaceutical packaging is to pierce the retaining layer or push the container until the medication breaks the retaining layer. However, there is a need to increase awareness for a packaging apparatus as these operations could be an obstacle for people affected by arthritis or with reduced hand dexterity. They do not have sufficient hand strength to exert force on the container to push the medications through the retaining layer, and hand mobility to grip the pharmaceutical packaging and push the container at the same time.

There are a few patented technologies over the prior art relating to the packaging apparatus. WO2016207918A1 discloses a laminate structure for making a blister laminate of a pharmaceutical packaging. The laminate structure includes a first layer, a second layer and a third layer. Each of the first layer and the third layer include a metallized PET film. The second layer is a multi-layer barrier film including a metallized surface. A lidding is provided to cover the blister laminate to form the pharmaceutical packaging.

Another packaging apparatus for medication is disclosed in JP5682856B2. This invention provides a packaging sheet having a child resistant and senior friendly (CRSF) function by which product is hardly pushed out from the packaging sheet such as a PTP sheet before the product is taken out from the packaging sheet, and the product is easily pushed out from the packaging sheet when the product is taken out from the packaging sheet.

However, the configuration of pharmaceutical packaging as disclosed in WO2016207918A1 and JP5682856B2 only allows user to access the medications by pushing the container until the medication breaks the retaining layer. Hence, the pharmaceutical packaging is not convenient for people affected by arthritis or with reduced hand dexterity.

Accordingly, it would be desirable to provide a packaging apparatus that utilises simple hand movements such as squeezing to actuate a releasing mechanism on the pharmaceutical packaging through specific design on the plastic container or the retaining layer.

### SUMMARY OF INVENTION

One object of the invention is to provide a packaging apparatus that uses hand squeezing strength to actuate a releasing mechanism on the packaging apparatus through specific design on the plastic container or the retaining layer. Another object of the invention is to provide a packaging apparatus that makes opening of the packaging apparatus easy and convenient, which facilitates users, especially those affected by arthritis, or is experiencing reduced hand dexterity to gain access to the product contained therein without the need to exert much force. In addition, the invention also allows users with just the use of one hand to open the packaging apparatus. Further, the invention omits the need of users to depend on the product contained inside the packaging apparatus to break the packaging apparatus as this would cause damage to the product. This invention offers a safe to use packaging apparatus that protects the users from cutting their hands when opening the packaging apparatus. Also, the invention protects the product contained therein from being contaminated. Besides that, although this invention is designed for allowing users to open the packaging apparatus for obtaining access to the product contained therein easily, it also contains features that enhances rigidness of the packaging apparatus, in particular, the pod such that when no force intended to open the packaging apparatus is exerted thereto, the packaging apparatus will not deform or break easily in order to protect the product contained therein.

One aspect of the invention provides a packaging apparatus comprising a pod containing product, and a retaining layer which closes the pod so that the product is held captive within the pod, the pod and/or the retaining layer has a predetermined frangible feature which provides a weakened portion in part of the surface of the pod and/or the retaining layer and thereby the weakened portion is broken by deforming the pod to get access to the product.

According to a feature of the invention, the product is released through an opening in the packaging apparatus formed by the broken weakened portion.

Preferably, the pod is configured so as to allow the pod to be deformed in a specific manner that breaks the weakened portion, thereby forming the opening in the packaging apparatus.

According to a further feature of the invention, the pod has a narrowing shape extending across middle of the pod to facilitate the pod to be deformed inwardly.

Preferably, the invention comprises a pair of similar pods, each of which is generally cuneiform, whereby the thinner end of each pod faces one another with the predetermined frangible feature located between the pods at the thinner ends.

Preferably, the packaging apparatus is opened to gain access to the product by moving the thicker ends of the pods towards one another such that the frangible feature between the pods at their thinner ends is broken.

Preferably, the retaining layer comprises a barrier film and/or a metal layer.

According to a feature of this aspect of the invention, the weakened portion is in the form of pre-cut disposed on the metal layer, whereby the deformation of the pod causes the metal layer to pierce through the barrier film to break the barrier film.

According to a further feature of the invention, the packaging apparatus has flaps adjacent to opposed sides of the pod, the flaps have pre-cuts to facilitate the pod to be deformed inwardly therefore causing the metal layer to pierce through the barrier film to break the barrier film.

According to a feature of this aspect of the invention, the weakened portion is in the form of pre-cut disposed on one surface of the pod, whereby the deformation of the pod causes the pre-cut to rupture at least partially along the pre-cut, therefore releasing the product through the opened pre-cut.

Preferably, the pod is configured with predetermined fold lines on at least one surface of the pod to control the deformation of the pod and to maintain the pod in its deformed open configuration.

According to a feature of this aspect of the invention, the packaging apparatus is a pharmaceutical package containing a medicinal product.

Preferably, the packaging apparatus is configured to be manipulated for opening by the user with one hand only.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a diagram illustrating an exploded view of a first embodiment of the packaging apparatus.

FIG. 2a-2b is a diagram illustrating functional use of the first embodiment of the packaging apparatus.

FIG. 3a-3c is a diagram illustrating real-life application of the first embodiment of the packaging apparatus.

FIG. 4 is a diagram illustrating an isometric view of a second embodiment of the packaging apparatus.

FIG. 5 is a diagram illustrating an isometric view of a third embodiment of the packaging apparatus.

FIG. 6 is a diagram illustrating an isometric view of a fourth embodiment of the packaging apparatus.

FIG. 7 is a diagram illustrating the fourth embodiment of the packaging apparatus with an opened configuration.

FIG. 8 is a diagram illustrating a fifth embodiment of the packaging apparatus according to the present invention.

FIG. 9 is a diagram illustrating an exploded view of the fifth embodiment of the packaging apparatus.

FIG. 10a-10b is a diagram illustrating the fifth embodiment of the packaging apparatus operable from a close configuration to an opened configuration.

FIG. 11a-11b is a diagram illustrating the fifth embodiment of the packaging apparatus configured to be manipulated for opening by the user with one hand only.

### DETAILED DESCRIPTION OF THE INVENTION

The present invention relates to a packaging apparatus which allows users with just the use of one hand to conveniently retrieve a product from the packaging apparatus. The packaging apparatus is also known as pharmaceutical packaging, having a pod and a retaining layer. The pod is preferably made of a semi-rigid or a rigid material with a portion having deep drawn recess which can be referred as compartments, pockets or wells that conveniently accommodates the product. In a preferred embodiment of the pod, the compartment is formed with a lip outwardly extending from periphery of the opening of the compartment. In application, the compartment is filled with the product and then sealed by the retaining layer that closes the pod through adhering the lip of the pod to the retaining layer so that the product is held captive within the pod. For example, and not by limitation, the packaging apparatus is a pharmaceutical packaging apparatus containing a medicinal product that may be in a solid, semi solid, gel or liquid form. However, the packaging apparatus can be used to contain other suitable organic, inorganic or composite materials such as cosmetic products, electronic components, foods and snacks.

By way of example, but not by way of limitation, the pod can be made of polymer material such as polyethylene terephthalate that allows the pod to be resistant to impact but is typically deformable when application of force exceeds a certain threshold.

Preferably, the retaining layer is of multilayer construction that includes at least one barrier film and one metal layer. Preferably, the barrier film is made of polyethylene terephthalate, ethylene vinyl alcohol and other suitable materials that are breakable through piercing or stretching to form an opening. The metal layer can be made of aluminium or any other suitable metals. However, the metal layer can be substituted, for example by a plastic layer.

Preferably, the metal layer is sufficiently thin but has sufficient thickness for rigidity to allow the metal layer to pierce through the barrier film when the metal layer is forced to deflect outwards of the pod.

Although, the invention can be presented in a number of different embodiments, and can incorporate a variety of different components and technologies, the various embodiments of the invention have some common elements. According to the concept of the invention, the packaging apparatus comprises a configuration that uses hand squeezing strength to release the product from the packaging apparatus. This can be carried out by the user with just a single hand. The configuration can be in the form of the pod and/or the retaining layer having a predetermined frangible feature which provides a weakened portion in part of the surface of the pod and/or the retaining layer and the weakened portion can be broken by deforming the pod to get access to the product.

The term “a predetermined frangible feature” as used herein refers to a characteristic of being able to be broken into fragments. The predetermined frangible feature is provided by a weakened portion in part of the surface of the pod and/or the retaining layer. The weakened portion has a substantially lower resistance to break compared to other areas of the surface of the pod and/or the retaining layer. The weakened portion would break first to form an opening thus releasing the product through the opening.

The invention will now be described in greater detail, by way of example, with reference to the drawings.

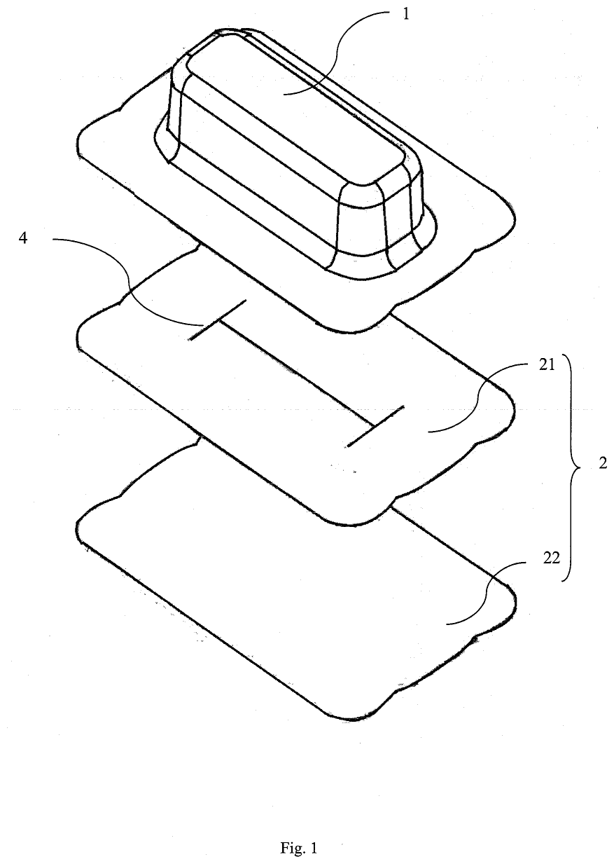

FIG. 1 illustrates a first embodiment of the packaging apparatus. In this particular embodiment, a retaining layer 2 has a predetermined frangible feature which provides a weakened portion 4 in part of the surface of the retaining layer 2 and thereby the weakened portion 4 is broken by deforming the pod 1 to get access to a product 3. The weakened portion 4 can be in the form of pre-cut, perforation, score line, fold line or any combination thereof that can be ruptured at least partially along the weakened portion 4 due to deformation of the pod 1. By way of example, but not by way of limitation, the weakened portion 4 is in the form of a pre-cut disposed on a metal layer, which is an aluminium layer 21 that is sandwiched between the pod 1 and a barrier film 22. In this particular embodiment, the pre-cut is a pattern composed of several lines formed by laser cutting. Other suitable technology can be employed to form the pre-cut on the aluminium layer 21.

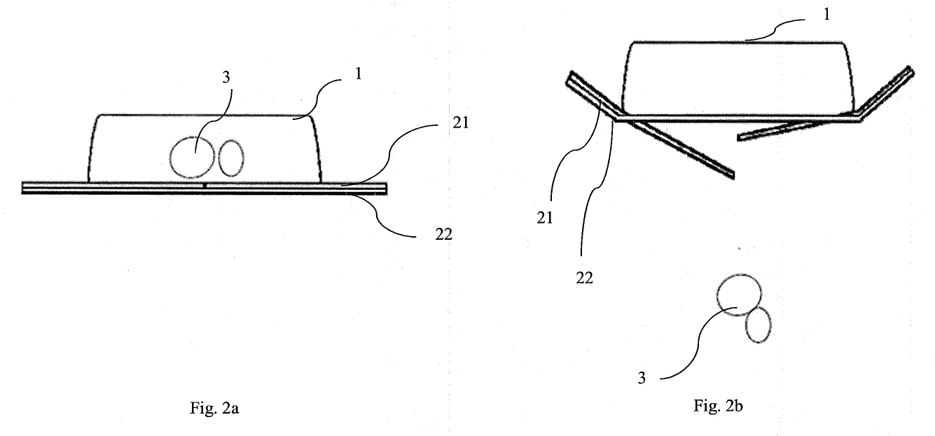

FIG. 2a and FIG. 2b show the functional use of the first embodiment of the packaging apparatus. FIG. 2a shows that the product 3 is held captive within the pod 1, while the metal layer is being sandwiched between the pod 1 and the barrier film 22. FIG. 2b shows that the deformation of the pod 1 renders the metal layer to be bent in such a way that the metal layer pierces through the barrier film 22. The pre-cut of the metal layer is forced to deflect outwards by the deformation of the pod 1, therefore piercing through the barrier film 22. Subsequently, the product 3 is released through the opening formed in the barrier film 22.

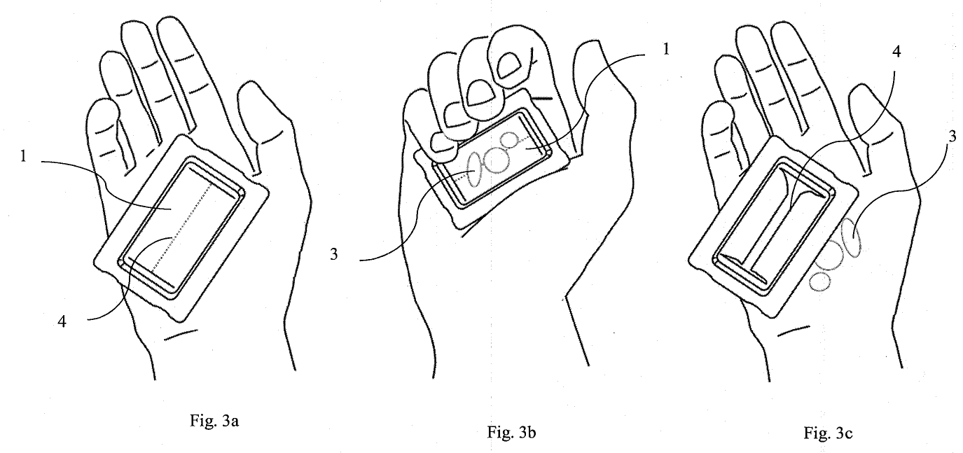

FIG. 3a to FIG. 3c illustrate the real-life application of the packaging apparatus by a user with only one hand. In this particular application, the barrier film 22 faces towards the palm when the packaging apparatus is held within the user's palm. When the user clenches his palm, opposite sides of the user's palm engage with opposite sides of the packaging apparatus, therefore causing the pod 1 to be squeezed inwardly. In one advantageous embodiment, the aluminium layer 21 pierces through the barrier film 22, forming the opening thus releasing the product 3 on the patient's palm. Further, the pod 1 is configured so as to allow the pod 1 to be deformed in a specific manner that breaks the weakened portion 4, thereby forming the opening in the packaging apparatus.

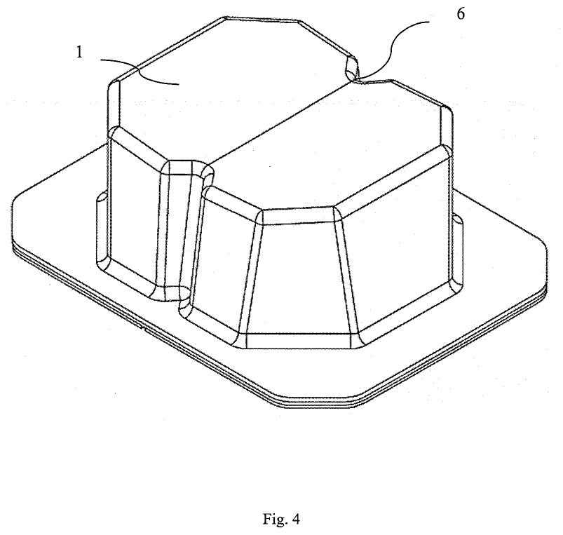

In a second embodiment as illustrated in FIG. 4, the pod 1 has a narrowing shape 6 extending across middle of the pod 1 to facilitate the pod 1 to be deformed inwardly during hand squeezing. Further, the middle of the pod 1 is configured to tilt inwardly and hence substantially nearer towards the retaining layer 2. Opposing sides of the pod 1 are configured with a generally inwardly concaved arc portion each which faces inward the pod 1, where the concaved arc portions are connected via the inwardly tilted portion of the pod 1, thus forming the narrowing shape 6 on the pod 1. Such configuration aids the pod 1 to be readily bent towards the retaining layer 2. The pod 1 will simply break into two halves simplifying the access to the product 3.

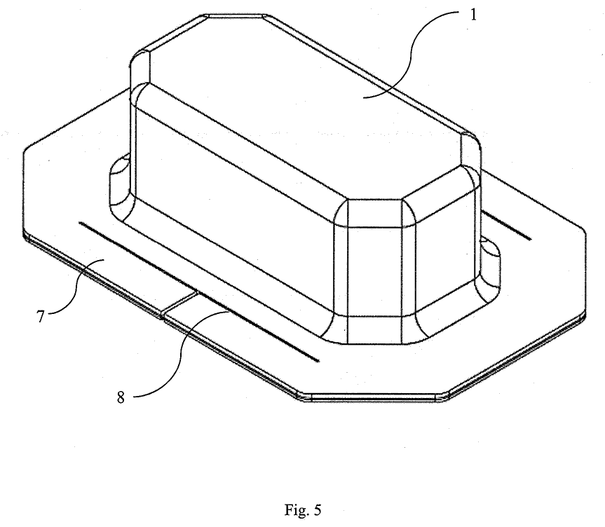

In a third embodiment as illustrated in FIG. 5, the packaging apparatus has flaps 7 adjacent to opposed sides of the pod 1. The flaps 7 are formed by the laminated lip of the pod and retaining layer 2. and have pre-cuts 8 to facilitate the pod 1 to be deformed inwardly therefore causing the metal layer to pierce through the barrier film 22 to break the barrier film 22. The pre-cuts 8 on the flaps 7 allow the pod 1 to react more flexibly to deformation.

Similarly, for the second and third embodiment, the deformation of the pod 1 renders the metal layer to be bent in such a way that the metal layer pierces through the barrier film 22. The pre-cut of the metal layer is forced to deflect outwards by the deformation of the pod 1, therefore piercing through the barrier film 22. Subsequently, the product 3 is released through the opening formed in the barrier film 22.

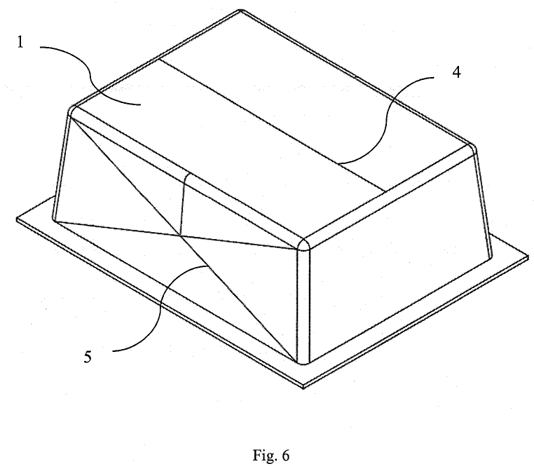

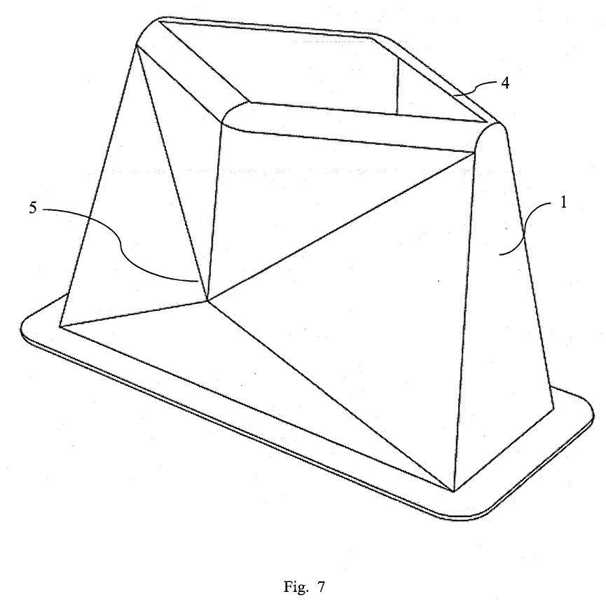

FIG. 6 and FIG. 7 show a fourth embodiment of the present invention. In this particular embodiment, the pod 1 has the predetermined frangible feature which provides the weakened portion 4 in part of the surface of the pod and the weakened portion 4 is broken by deforming the pod 1 to get access to the product 3. The weakened portion 4 can be in the form of pre-cut, perforation, score line, fold line or any combination thereof that can be ruptured at least partially along the weakened portion 4 due to deformation of the pod 1. By way of example, but not by way of limitation, the weakened portion 4 is a pre-cut disposed on one surface of the pod 1. In this particular embodiment, the pre-cut is composed of a line extending across the surface.

In this particular application as depicted in FIG. 7, the surface with pre-cut of the pod 1 faces away from the palm when the packaging apparatus is held within a user's palm. When the user clenches his palm, opposite sides of the user's palm engage with opposite sides of the packaging apparatus, therefore causing the pod 1 to be squeezed inwardly. Preferably, the pod 1 is configured with predetermined fold lines 5 on at least one surface of the pod 1 to control the deformation of the pod 1 and to maintain the pod 1 in its deformed open configuration. The deformation of the pod 1 renders the pre-cut on the pod 1 to rupture at least partially along the pre-cut, therefore releasing the product 3 through the opened pre-cut.

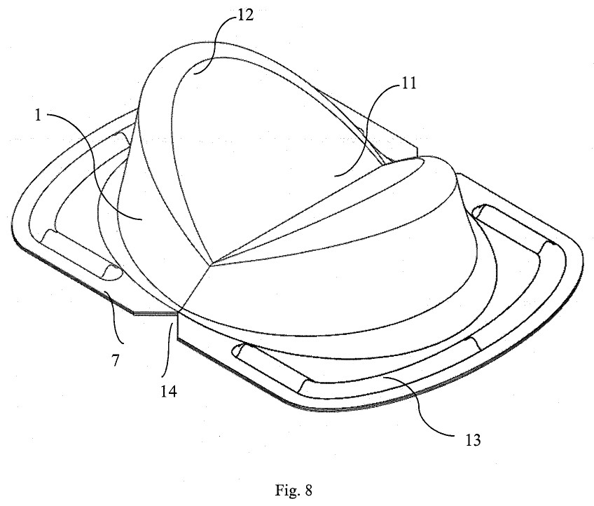

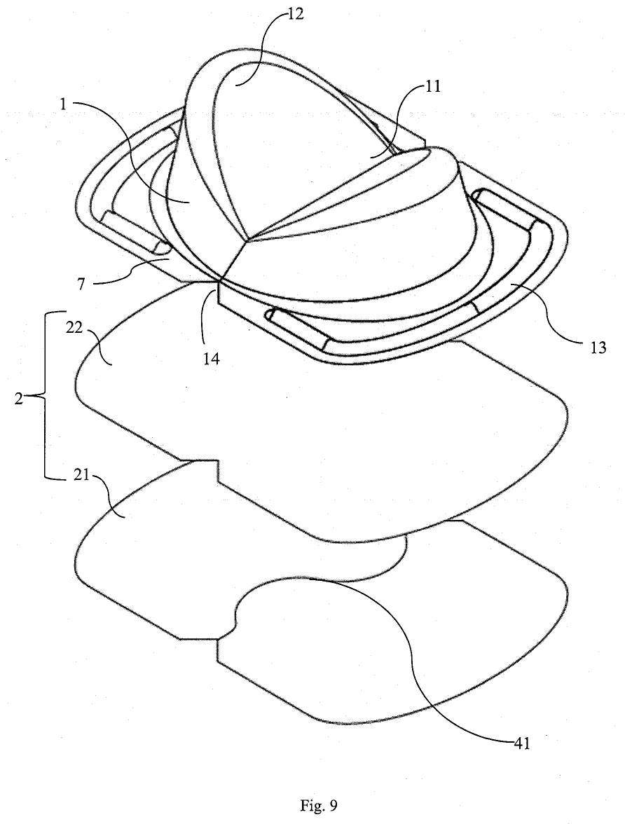

FIG. 8 and FIG. 9 illustrate a fifth embodiment of the packaging apparatus according to the present invention. The packaging apparatus comprises a pair of similar pods 1 containing product 3 and a retaining layer 2 which closes the pair of similar pods 1 so that the product 3 is held captive within the pair of similar pods 1. In one preferred embodiment, each of the pod 1 is generally cuneiform, which defines a slanted surface 13 extending from one end to another end of the pod 1. Such configuration provides the pod 1 with a thinner end 11 and a thicker end 12 disposed as to oppose one another. Preferably, the thinner end 11 of each pod 1 faces one another with the predetermined frangible feature located between the pods 1 at the thinner ends 11. The predetermined frangible feature can be in the form of pre-cut, perforation, score line, fold line or any combination thereof that can be ruptured at least partially along the predetermined frangible feature due to deformation of the pod 1.

In this particular embodiment, the retaining layer 2 comprises a barrier film 22 and a metal layer. Preferably, the barrier film 22 is sandwiched between the metal layer and the pair of pods 1. By way of example but not by limitation, the metal layer is an aluminium layer 21 having a substantially S-shaped pre-cut 41.

Preferably, the lip of the pod 1 is formed by protruded portions 13 for enhancing rigidity of the pod such that the pod 1 is not easily deformed when no force for opening the packaging apparatus to gain access to the product 3 is exerted thereto. In addition, flaps 7 are provided in the fifth embodiment of the invention. A v-shaped cut 14 is formed in between two adjacent flaps that extends towards the compartment of the pod to assist the pod 1 to be deformed inwardly when a force intended to open the packaging apparatus is exerted thereto.

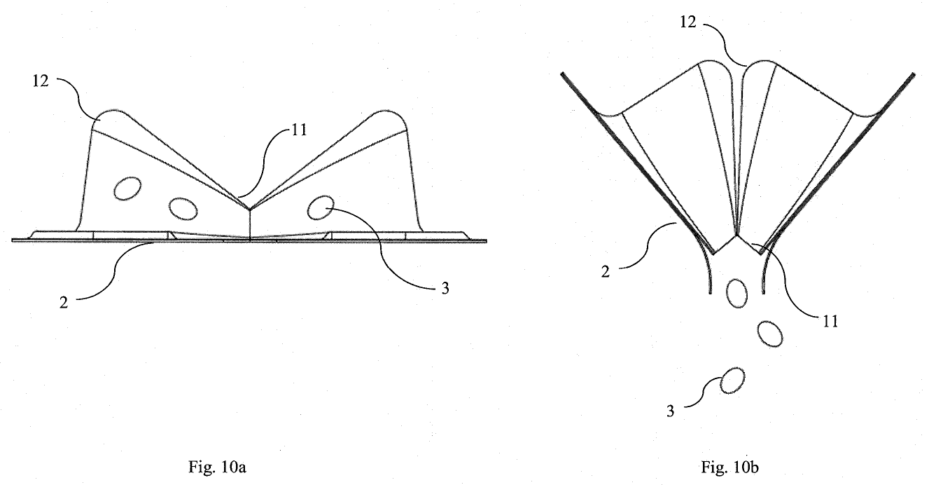

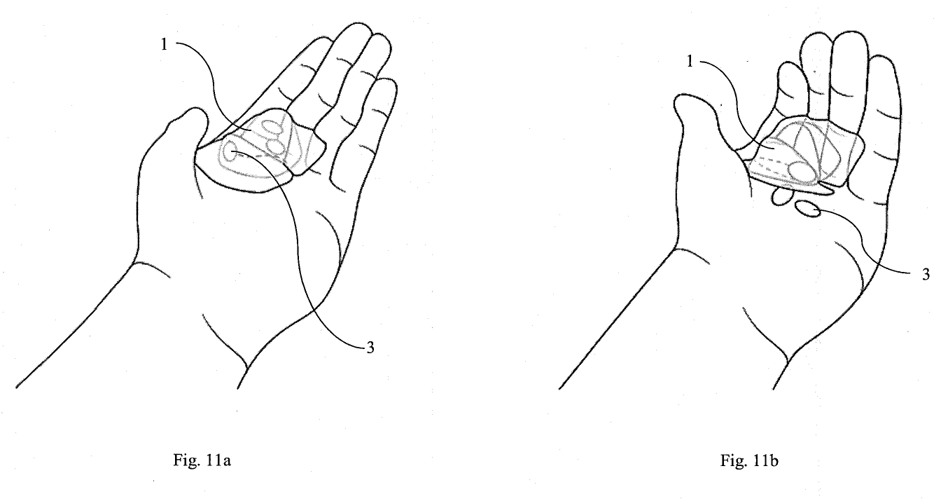

Referring to FIG. 10a to FIG. 11b, the packaging apparatus is configured so that it can be manipulated for opening by the user with one hand only. When the user clenches his palm, the opposite sides of the user's palm engage with the thicker ends 12 of the pod. The pod 1 is squeezed inwardly by moving the thicker ends 12 of the pods 9 towards one another to break the predetermined frangible feature between the pods 1.

The predetermined frangible feature of the pods 1 ruptures and the rupture extends towards both ends of the substantially S-shaped pre-cut 41. The deformation of the pod 1 causes the metal layer to be bent in such a way that the substantially S-shaped pre-cut 41 on the metal layer breaks from its ruptured ends. At least part of the substantially S-shaped pre-cut 41 is forced to deflect inwards due to the deformation of the pod 1, therefore piercing through the barrier film 22. Subsequently, the product 3 is released through the opening formed in the barrier film 22.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1.-13. (canceled)

14. A packaging apparatus, comprising:
a pod containing a product;
a retaining layer that closes the pod so that the product is held captive within the pod;
wherein the pod or the retaining layer has a predetermined frangible feature that provides a weakened portion in part of a surface of the pod or the retaining layer; and
wherein the weakened portion is broken by deforming the pod to get access to the product.

15. The packaging apparatus according to claim 14, wherein the product is released through an opening in the packaging apparatus formed by the broken weakened portion.

16. The packaging apparatus according to claim 14, wherein the pod is configured so as to allow the pod to be deformed in a manner that breaks the weakened portion, thereby forming the opening in the packaging apparatus.

17. The packaging apparatus according to claim 14, wherein the pod has a narrowing shape extending across a middle portion of the pod to facilitate the pod to be deformed inwardly.

18. The packaging apparatus according to claim 14, further comprising a pair of similar pods, each of which is generally cuneiform, whereby a thinner end of each pod faces one another with the predetermined frangible feature located between the pods at the thinner ends.

19. The packaging apparatus according to claim 18, wherein access to the product is achieved by moving thicker ends of the pods towards one another such that the frangible feature between the pods at their thinner ends is broken.

20. The packaging apparatus according to claim 19, wherein the retaining layer comprises a barrier film or a metal layer.

21. The packaging apparatus according to claim 20, wherein the weakened portion is in the form of a pre-cut disposed on the metal layer, such that deformation of the pod causes the metal layer to pierce through the barrier film to break the barrier film.

22. The packaging apparatus according to claim 21, further comprising flaps adjacent to opposed sides of the pod, the flaps having pre-cuts to facilitate the pod to be deformed inwardly for causing the metal layer to pierce through the barrier film to break the barrier film.

23. The packaging apparatus according to claim 22, wherein the weakened portion is in a form of a pre-cut disposed on one surface of the pod, whereby the deformation of the pod causes the pre-cut to rupture at least partially along the pre-cut, therefore releasing the product through the opened pre-cut.

24. The packaging apparatus according to claim 23, wherein the pod is configured with predetermined fold lines on at least one surface of the pod to control the deformation of the pod and to maintain the pod in its deformed open configuration.

25. The packaging apparatus according to claim 14, wherein the packaging apparatus is a pharmaceutical package containing a medicinal product.

26. The packaging apparatus according to claim 14, wherein the packaging apparatus is configured so that it can be manipulated for opening by a user with one hand only.
